(19) United States
(12) Patent Application Publication
(10) Pub. No.: US 2025/0005495 A1
(43) Pub. Date: Jan. 2, 2025

(54) ADAPTIVE PROCESS REPRESENTATION

(71) Applicant: International Business Machines Corporation, Armonk, NY (US)

(72) Inventors: Jayachandu Bandlamudi, Guntur (IN); Kushal Mukherjee, New Delhi (IN); Prerna Agarwal, New Delhi (IN); Renuka Sindhgatta Rajan, Bengaluru (IN)

(21) Appl. No.: 18/342,047

(22) Filed: Jun. 27, 2023

(51) Int. Cl. G06Q 10/0639; G06Q 10/0633; G06Q 10/067

(52) U.S. Cl. CPC G06Q 10/06395; G06Q 10/0633; G06Q 10/06393; G06Q 10/067

(57) ABSTRACT

Methods and systems for process analysis include determining attributes of an event log relating to a process. Attributes of an end task of the process are determined based on a comparison of a vector representation of the end task to vector representations to a set of criteria relating to process representations. Hyper-parameters of process mining models are tuned based on the attributes of the event log and the attributes of the end task. The process mining models are ranked based on the attributes of the event log and the attributes of the end task. The event log is mined using a top-ranked process mining model to generate a process representation. An inefficiency of the process is identified based on the process representation. The inefficiency is automatically corrected.

### BACKGROUND

The present invention generally relates to process mining and, more particularly, to adaptive process representation.

Process mining applies data science to discover, validate and improve workflows. By combining data mining and process analytics, organizations can mine log data from their information systems to understand the performance of their processes, revealing bottlenecks and other areas of improvement. Process mining leverages a data-driven approach to process optimization, allowing managers to remain objective in their decision-making around resource allocation for existing processes.

However, there are multiple different ways to perform process mining and multiple different ways to represent the process itself. Some process mining algorithms may be better suited to particular types of task than others, and similarly some process representations may better capture the relevant information than others.

### SUMMARY

A method of process analysis includes determining attributes of an event log relating to a process. Attributes of an end task of the process are determined based on a comparison of a vector representation of the end task to vector representations to a set of criteria relating to process representations. Hyper-parameters of process mining models are tuned based on the attributes of the event log and the attributes of the end task. The process mining models are ranked based on the attributes of the event log and the attributes of the end task. The event log is mined using a top-ranked process mining model to generate a process representation. An inefficiency of the process is identified based on the process representation. The inefficiency is automatically corrected.

A system of process analysis includes a hardware processor and a memory that stores a computer program. When executed by the hardware processor, the computer program causes the hardware processor to determine attributes of an event log relating to a process, to determine attributes of an end task of the process based on a comparison of a vector representation of the end task to vector representations to a set of criteria relating to process representations, to tune hyper-parameters of a plurality of process mining models based on the attributes of the event log and the attributes of the end task, to rank the plurality of process mining models based on the attributes of the event log and the attributes of the end task, to mine the event log using a top-ranked process mining model of the plurality of process mining models to generate a process representation, to identify an inefficiency of the process based on the process representation, and to automatically correct the inefficiency.

These and other features and advantages will become apparent from the following detailed description of illustrative embodiments thereof, which is to be read in connection with the accompanying drawings.

### BRIEF DESCRIPTION OF THE DRAWINGS

The following description will provide details of preferred embodiments with reference to the following figures wherein:

FIG. 1 is a diagram of a directly follows graph representation for a given process, in accordance with an embodiment of the invention;

FIG. 2 is a block/flow diagram of a method for selecting an optimal process representation and using the optimal process representation to correct an inefficiency of the process;

FIG. 3 is a diagram of a heuristic miner graph representation for a given process, in accordance with an embodiment of the present invention;

FIG. 4 is a block diagram of a process optimization system that selects an optimal process representation from a group of process representations, in accordance with an embodiment of the present invention;

FIG. 5 is a block/flow diagram of a method of process optimization using a process representation, in accordance with an embodiment of the present invention; and

FIG. 6 is a diagram of an exemplary computing environment that can perform adaptive process representation and correction, in accordance with an embodiment of the present invention.

### DETAILED DESCRIPTION

Generating a graphical representation of a process can help to visualize and understand the different stages of the process and how they relate to one another. Various kinds of representations can be generated, using analytics such as time overlays, bottlenecks, and loop analysis. Additionally, there are different ways of characterizing a process and different approaches to process discovery, making it difficult to select the most accurate graphical representation for a given process. Some models, such as spaghetti models, may be too complicated to easily understand, while other models may be too simple to accurately capture the process. These challenges are amplified when generating representations for end-users who may not be familiar with the technical details of process discovery and the annotations used to describe it.

The hyperparameters of process discovery may therefore be tuned and the best process representation may be selected in a dynamic fashion, responsive to the characteristics of the process itself. In particular, these parameters may be selected responsive to features such as quality criteria, user-specified key performance indicators (KPIs), end tasks, and data quality. A ranked list of representations can be generated, with annotations provided that identify tradeoffs in the selection between given models.

In addition, some approaches to process mining are ill-suited to particular problems. For example, some notations by design cannot describe concurrent path, which can cause process mining to produce an under-fit or an over-fit. The dynamic representation described herein provides a unified framework for selecting the best process discovery model and the best process notation for a given application.

Various criteria may be employed during process mining to characterize an accurate representation. For example, criteria may include fitness, precision, generalization, and simplicity. These criteria may be used to rank the accuracy of a given process representation. Other dimensions that may be considered for accurate process discovery may include data quality, the end task, and user-defined KPIs.

According to an aspect of the invention, there is provided methods and systems for process analysis. Attributes of an event log relating to a process are determined. Attributes of an end task of the process are determined based on a comparison of a vector representation of the end task to vector representations to a set of criteria relating to process representations. Hyper-parameters of process mining models are tuned based on the attributes of the event log and the attributes of the end task. The process mining models are ranked based on the attributes of the event log and the attributes of the end task. The event log is mined using a top-ranked process mining model to generate a process representation. An inefficiency of the process is identified based on the process representation. The inefficiency is automatically corrected. Selecting the best process representation for a given task makes it possible to automatically improve the efficiency of the process, such as in the case of a software process, by effectively identifying states where the software process frequently returns to or waits for long periods of time.

In embodiments, tuning the hyper-parameters includes using reinforcement learning to identify a set of hyper-parameters for a process mining model that maximizes a reward based on a set of criteria. Tuning these hyper-parameters improves the efficacy of the overall process mining by optimizing each of process mining models and representations.

In embodiments, the set of criteria includes fitness, precision, generalization, and simplicity. These criteria are used to characterize the efficacy of a given process model in representing the process.

In embodiments, the reinforcement learning further uses a user-defined key performance indicator to identify the set of hyper-parameters. The user-defined key performance identifier makes it possible for the user to establish the parts of the process that are of particular import when selecting the optimal representation.

In embodiments, ranking the plurality of process mining models includes matching text of the attributes of the end task to text of a knowledge base that describes attributes of a plurality of end tasks as they relate to process models. Matching the text makes it possible to rank process models according to information that is provided in a knowledge base.

In embodiments, the attributes of the end task and the attributes of the plurality of process mining models are represented as vectors and matching includes identifying similarities between the vectors. Representation of these attributes as vectors makes it possible to use language models and to manipulate the text and to rapidly assess similarities.

In embodiments, the attributes of the plurality of end tasks include whether activity executions are important to the end task, whether key process indicators or metric overlays are needed for the end task, whether particular organizational information is needed for the end task, and whether process replay and simulations are needed for the end task. These attributes help to specify which features of a given process model or representation are particularly helpful in assessing the process.

In embodiments, the plurality of process models include a process discovery method selected from the group consisting heuristic net, heuristic miner, fuzzy miner, alpha miner, and inductive miner. The use of a variety of process models makes it possible to handle a wide variety of different processes.

In embodiments, the plurality of process models include a representation selected from the group consisting of business process modeling notation, place/transition nets, process trees, and directly follows graphs. The use of a variety of representations makes it possible to handle a wide variety of different processes.

In embodiments, automatically correcting the inefficiency includes modifying a software program that performs the process to improve an efficiency of the software program. The automatic modification of the software program provides an improvement to a computer system, as it can dynamically adapt to the detection of inefficiencies in a software process.

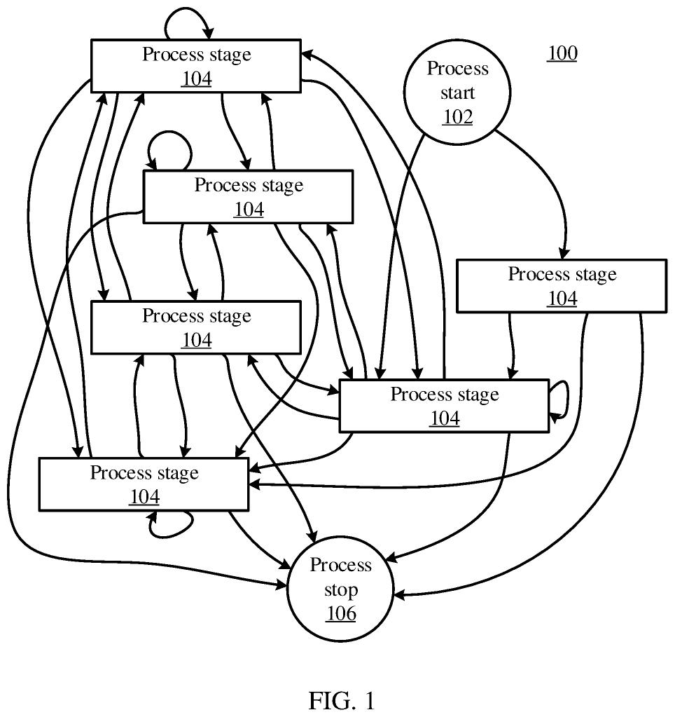

Referring now to FIG. 1. a diagram of a simple process graph is shown. This process starts at process start 102 and ends at process stop 106. Between these two points, the process may traverse a number of different process stages 104. In some cases a given process may reach each stage once before coming to process stop 106, but in other cases some stages may used more than once, and in still other cases some stages may not be reached by a given process at all. This representation is a directly-follows graph (DFG) 100 that encodes the relationships between the process stages 104 in the edges of the graph. As shown in the DFG 100, some process stages 104 may return to themselves and some may proceed to only a small subset of the available stages.

A DFG may be generated from an event log that records the events that occur during a process. For example, if an event B directly follows an event A in time, then the DFG may include a directed edge from A to B. The graphical representation of the DFG may include additional information, for example maintaining a count of the number of times each process stage 104 is visited and a count of the number of times each edge is traversed. This gives the user an understanding of how much time the process spends in each state and the overall path that the process is likely to take.

Even with only six process stages 104, the DFG 100 rapidly becomes visually complex. Additionally, rare events are shown in the DFG 100 with just as much visual priority as common events, making it difficult to glean important information. A DFG therefore may not be the best model for every application, such as when the goal is to identify which process stage 104 occupies the most time and, therefore, would benefit most from optimization. Other representations may provide a superior perspective on the important facets of the process.

Other types of process mining and representation may therefore be used instead, as appropriate. These include business process modeling notation (BPMN), place/transition nets, and process trees. Furthermore, different types of process discovery (also known as process mining) may be used to extract the process's information from a set of event logs. These may include heuristic net, heuristic miner, fuzzy miner, alpha miner, and inductive miner.

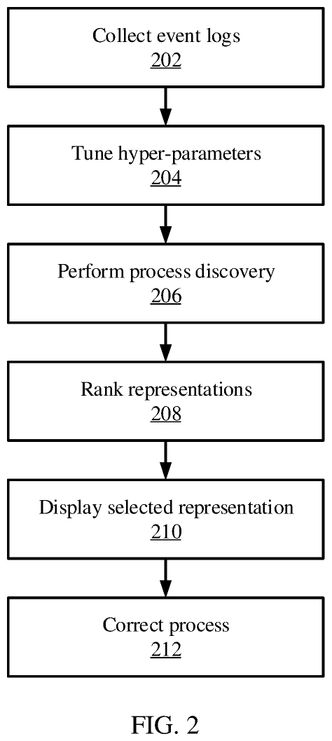

Referring now to FIG. 2, a method of process mining is shown. Block 202 collects event logs for a process. In some embodiments, these event logs may include logs of system calls for a software application. In some embodiments, the event logs may further include actions performed on the software application, such as user interactions and inputs.

Block 204 tunes the hyper-parameters of one or more process mining models. This tuning may be performed based on factors such as data quality, user-defined KPIs, and a knowledge base for end tasks. For example, a trained reinforcement learning model can be used, with the data quality, user-defined KPIs, and end task being input to generate a set of hyper-parameters that will provide the best results in a given instance. The reinforcement learning may use a Q-learning value-based method to identify optimal hyperparameters that satisfy the quality criteria. In some embodiments, Bayesian methods may be used to tune the hyper-parameters.

A hyper-parameter policy may be defined based on:

π=(γ,loop_length,noise_threshold,data_quality,KPIs,end_tasks)

where γ is a hyper-parameter corresponding to process discovery. Using a current set of hyper-parameters, the precision, simplicity, fitness, and generalization may be determined as described below. The reward function may be generated based on the quality criteria, the data quality, and the user KPIs. For example, reward may be calculated as:

$$R = \sum W \cdot C$$

$$C = ( precision , simplicity , fitness , generalization )$$

where W is a weight vector used to compute the weighted average of C as a reward. The hyper-parameter policy π is selected to generate the maximum reward R.

The tuning may start by initializing process algorithm-specific hyper-parameters with appropriate values. The initial values may be used as the current policy π of the Q-learning. For a current set of hyper-parameters and process representation, the fitness, precision, generalization, simplicity, data quality, user KPI, and end task information are determined. The reward for the current policy may be computed as above, and the policy may be updated to a new set of hyper-parameters.

This reward determination and policy update may be repeated until a stopping condition is reached, at which point the highest reward may be used to identify the best set of hyper-parameters. The stopping condition may be defined by the possible combinations of hyper-parameters in the policy. For example, different sets of all possible combinations of hyper-parameters in the policy may be obtained and the reward may be determined for each set.

Process discovery 206 is performed on the event logs, using one or more process mining approaches that are configured according to the tuned hyper-parameters. In particular, it is contemplated that multiple different process mining approaches may be used on the same event logs to generate different respective representations of the process. Each type of process mining may represent the process in a different way. Additionally, multiple different types of notation may be used to render the representations, resulting in different views of a representation generated by a given process mining approach. Thus block 206 may generate multiple different combinations of process mining outputs and notations.

Block 208 ranks the representations according to one or more metrics, such as fitness, precision, generalization, simplicity, user KPIs, end tasks, and data quality. Fitness is a measure of the ability of a model to reproduce the behavior contained in the event log. Under trace semantics, a fitness value of 1 indicates that the model can reproduce every trace in the log. Thus, fitness may be characterized as the number of traces reproduced by the model, divided by the total number of traces.

Precision measures the ability of a model to generate only the behavior found in the log. A score of 1 indicates that any trace produced by the model is contained in the log. Thus, precision may be characterized as the number of log traces reproduced by the model, divided by the total number of traces produced by the model.

Generalization indicates the ability of the process mining to discover process models that generate traces not present in the log, but that would eventually be produced by the process if additional events were collected. Thus, generalization may be characterized as the number of model traces that are not in the log, divided by the total number of traces that are produced by the model.

Simplicity indicates how difficult it is for a person to understand the model. Simplicity may be measured using a complexity metric such as size (relating to the number of nodes in a representation), control-flow complexity (relating to the amount of branching caused by gateways in the model), or any other appropriate metric. One particular formulation of simplicity may be characterized as one divided by the sum of the size and the control-flow complexity. As noted above, the reward score R may be formed from a weighted combination of multiple metrics C, and the different representations may be sorted based on the reward score, with the representation having the highest reward being selected.

Data quality metrics may be based on factors such as missing values, outliers, temporal aspects, and activity imbalance. This information may be derived from the event logs and may be used to identify tradeoffs between process models. For example, an event log may be represented in a table with a set of columns representing different types of information. Rules may impose thresholds, for example establishing a maximum percentage of outliers or activity imbalance. The data quality may be output as quantized data quality criteria bins. For example, missing values may be determined as the number of values not present in a given column, divided by the total number of expected values in the column. Outliers may be determined as a number of values falling outside an expected normal distribution of values in a column, divided by a total number of values in the column. Activity imbalance may be determined as a ratio of pairwise activity frequencies. The data quality bin may then be calculated based on the input rules. For example, if the rules specify a maximum of 10% outliers, then event logs having a greater percentage of outliers may be pre-processed to bring the event logs within the specified threshold. The data quality metrics can then be re-run on the pre-processed event logs.

Data quality metrics may be specified by a process user, such as an administrator. By considering these metrics in the determination of the reward score, the tradeoff between data quality metrics may be identified to determine whether the metrics improve the overall reward. The reward score may be maximized with the given data quality metrics to identify the best representation.

User-specified KPIs may include, for example, time duration, frequency, and attribute values, and may further be used to compare process model tradeoffs. For example, an event log may have a set of case attributes. Rules may be specified, for example setting thresholds for the attributes such as specifying a minimum frequency. The output may be quantized into user KPI criteria bins. Time duration may be determined as the duration of each activity in a trace. Frequency may be determined as the number of occurrences of each activity in a trace. Attribute value may be determined as the average value of an attribute across the traces in the event log. The KPI bin value may then be calculated based on the input rule. For example, if the rules specify a frequency of at least five, then any activity occurring less frequently in the event log may be filtered out.

User KPIs may be specified by the process user, such as the administrator. By including the user KPIs in the reward score determination, the tradeoff for user KPIs may be considered in determining whether these metrics improve the overall reward.

The ranking may also be guided by specific knowledge base rules that depend on the end task. For example, certain types of process model mining and representation are better suited for certain types of tasks. Criteria may include whether concurrent activity executions are important to the end task, whether KPI or metric overlays are needed, whether particular organizational information is needed in the representation, and whether process replay and simulations are needed. A knowledge base of these criteria, and associated preferred process mining models and representations, may be checked against the attributes of the task to filter out inappropriate options from the ranking and to influence the ranking value of each.

Thus, ranking 208 may use the rules of the knowledge base, represented as a feature vector by natural language processing. A given end task may similarly be converted into a feature vector, and a matching score between the end task and the rules of the knowledge base may be determined using a similarity metric (e.g., cosine similarity). Based on this comparison, model types identified by the rules may be ranked against one another, and the top-ranked model type may be used.

Block 210 displays a selected representation, for example selecting the top-ranked representation or allowing a user to make a selection. Making this selection may include a review of tradeoffs between the different representations, for example identifying when accuracy is sacrificed for the sake of visual simplicity. Thus, block 210 may include a separate selection step that displays the tradeoffs of the representations and accepts an input from the user.

Based on the displayed representations, the user may make corrections to the process in block 212, for example to improve the efficiency of the process or to remove points where the process tends to hang. In some cases, this step may be performed automatically responsive to a computerized analysis of the process representations.

One example of an automated optimization that may be performed by block 212 is in invoice handling, where approving a given invoice amount is a bottleneck activity that may need several levels of approvals. To improve efficiency for the invoice amount, for example for invoices less than a predetermined amount, block 212 may automatically alter the process to remove redundant approvals that would otherwise simply introduce inefficiencies. Another example of automated optimization includes an incident ticket management environment, where multiple activities and alerts may be triggered by a single ticket. Generating alerts for trivial incidents causes inefficiencies, so alerts should be generated based on the nature of the incident, including factors such as severity and criticality. The automated optimization can identify such inefficiencies and change the relevant policies for low-priority tickets.

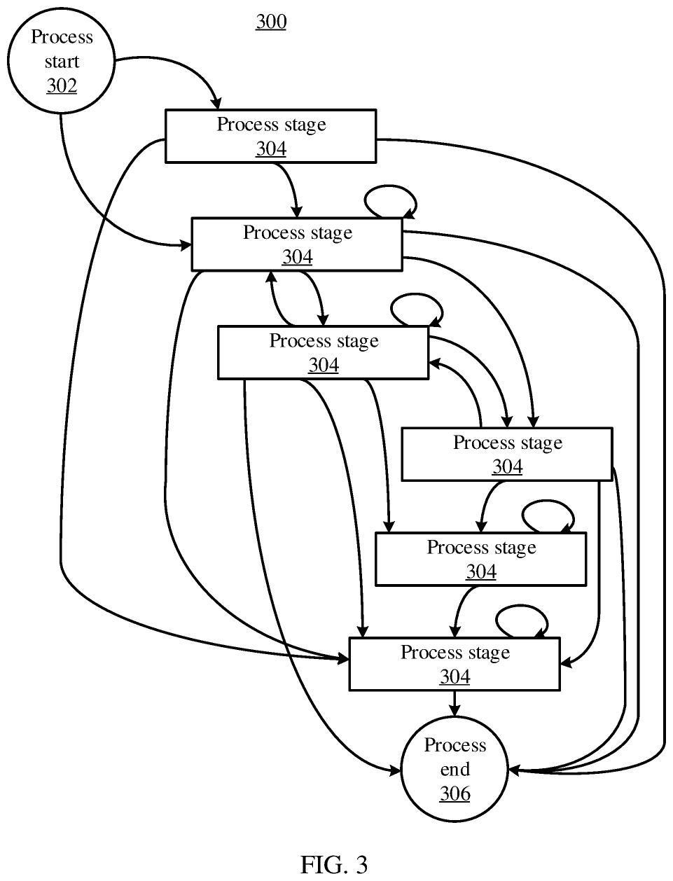

Referring now to FIG. 3, a heuristic miner representation 300 is shown of the same process identified by the DFG 100 described above. As with the DFG 100, the process begins at process start 302 and ends and process end 306, traversing one or more process steps 304 in the path from start 302 to end 306. In this heuristic miner representation 300, although the process steps 304 are the same as the process steps 104 of the DFG representation 100, the edges connecting them differ, with the heuristic miner 300 representation including fewer edges than the DFG 100.

In contrast to DFGs, heuristic miner representations are relatively noise tolerant and can be used to more clearly illustrate process behavior in noisy data. For example, a heuristics miner may consider the order of events within a process instance, creating an event log table that identifies the originator of an activity, a time stamp, and activities considered during the mining. The dependency graph may then be constructed, with input and output expressions for each activity. Long-distance dependency relations may further be identified. The frequency of events may be considered. The end result is a graph that describes events that are either exclusively dependent on each other or that are independent from one another. As with the DFG 100, the heuristic miner representation 300 may track information for how often each edge in the graph is traversed.

Because heuristic miner provides a relatively simplified view of the process, it can be useful for complicated and noisy processes. However, that simplicity risks omitting important events that may occur infrequently or that otherwise are not captured by heuristic miner's approach. Thus, there are tradeoffs in the decision of whether to use a heuristic miner representation 300 or a DFG representation 100. The present embodiments can therefore guide that decision in accordance with the nature of the process, the data quality metrics, and user-defined factors as described above.

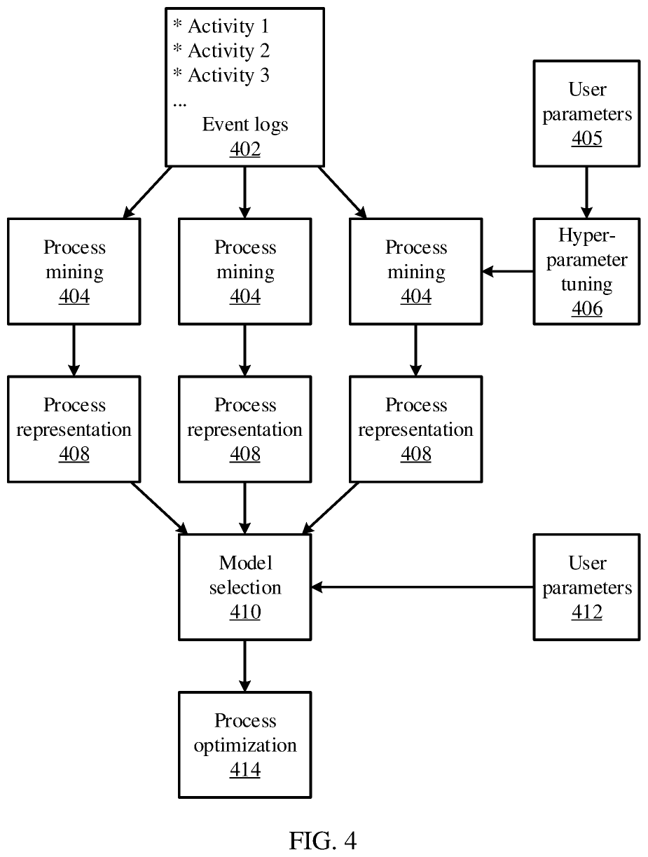

Referring now to FIG. 4, a diagram of process optimization 414 is shown. A set of event logs 402 relating to the process is shown. These event logs 402 may be in any appropriate format. For example, the event logs may be execution logs collected by an operating system, collecting together information relating to system calls, file accesses, network activity, and other actions relating to the execution of software functionality.

The event logs 402 may be analyzed by multiple process mining approaches 404. These process mining approaches 404 may include a variety of different process mining algorithms and process representation techniques, and each may have a different respective set of hyper-parameters that guide its function. These hyper-parameters are set by hyper-parameter tuning 406, which may be implemented as a reinforcement learning model that accepts user-specified parameters 405 in combination with the metrics described above to optimize the performance of the process mining 404.

Each process mining 404 generates a different respective process representation 408 of the event logs 402. As described above, the different process representations 408 may include different sets of information, shown in different ways. Some of these process representations may be better suited for a given process end task than others. Model selection 410 therefore ranks the process representations 408 in accordance with information from a knowledge base and user-provided information 412, for example information relating to the end task. A machine learning language model may be used to identify matches between the user-provided information and entries in the knowledge base, to identify tradeoffs and priorities that may be used in model selection 410 to identify the best process representation 408 for the task.

Based on the selected process representation 408, process optimization 414 may be performed. As noted above, process optimization 414 may include using the process representation to identify inefficiencies in the process and to make changes to the process itself. In the case of a software process, for example, the process optimization 414 may locate points at which the process waits or loops and may automatically change the software itself to eliminate these inefficiencies. For example, a piece of software may stall waiting for a file access to complete over a slow data bus. In such an instance, the software may be optimized to perform other tasks while waiting for the file access to complete, or to pre-load certain types of information to keep the needed information in a high-speed memory and thereby to reduce the need for the slower data bus.

Following this example of a stalling software process, the selected process representation 408 may maintain information relating to how long, or how often, the process spends time in a waiting state. Such information may indicate a point of inefficiency in the process that degrades user experience and decreases the performance of the computer itself. In some cases, optimizing the process may use, for example, a trained language model that accepts as input the source code for the software and that makes changes based on the selected process representation 408, recompiling and executing the altered software automatically to increase the system's efficiency.

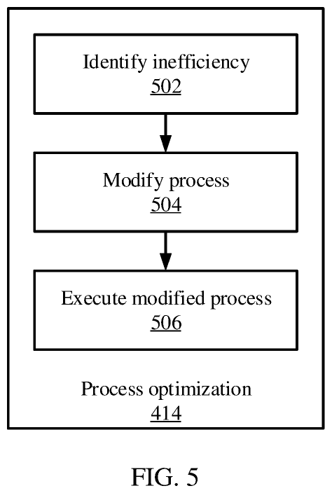

Referring now to FIG. 5, additional information is provided relating to process optimization 414. Using the process model 408 that is selected by model selection 410, block identifies an inefficiency. This identification may be performed automatically or manually by a user or administrator. In an example of automatic identification, block 502 may determine a task in the process that is repeated often, or may identify specific tasks or types of tasks that represent inefficiencies where the process spends time. Examples of such tasks may include points where human interaction or approval is needed, or where relatively slow data transfers are being performed by a software process.

Block 504 modifies the process to correct or decrease the impact of the identified inefficiency. This step may be performed automatically or manually be a user or administrator. In an example of an automatic modification, software source code may be automatically altered, for example using a language learning model that is trained on programming languages and optimizations, to optimize a software process. For example, the software process may be modified to perform another task while waiting for the waiting task to complete, or may select an alternative algorithm that decreases the importance of the waiting task or eliminates it entirely.

After the process has been modified, block 506 executes the modified process. In this manner, the inefficient process may be corrected and a fix may be implemented in-place, without requiring a human's intervention.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), FPGAs, and/or PLAs.

These and other variations of a hardware processor subsystem are also contemplated in accordance with embodiments of the present invention.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

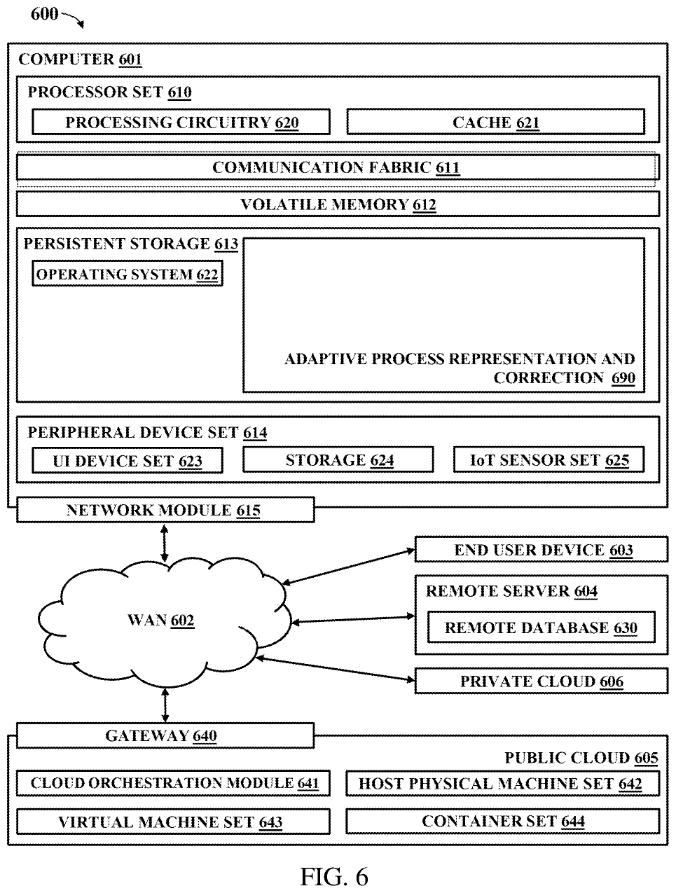

Referring now to FIG. 6, a diagram of an exemplary computing environment 600 is shown. Computing environment 600 contains an example of an environment for the execution of at least some of the computer code involved in performing the inventive methods, such as adaptive process representation and correction 690. In addition to block 200, computing environment 600 includes, for example, computer 601, wide area network (WAN) 602, end user device (EUD) 603, remote server 604, public cloud 605, and private cloud 606. In this embodiment, computer 601 includes processor set 610 (including processing circuitry 620 and cache 621), communication fabric 611, volatile memory 612, persistent storage 613 (including operating system 622 and block 200, as identified above), peripheral device set 614 (including user interface (UI) device set 623, storage 624, and Internet of Things (IoT) sensor set 625), and network module 615. Remote server 604 includes remote database 630. Public cloud 605 includes gateway 640, cloud orchestration module 641, host physical machine set 642, virtual machine set 643, and container set 644.

COMPUTER 601 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 630. As is well understood in the art of computer technology, and depending upon the technology, performance of a computer-implemented method may be distributed among multiple computers and/or between multiple locations. On the other hand, in this presentation of computing environment 600, detailed discussion is focused on a single computer, specifically computer 601, to keep the presentation as simple as possible. Computer 601 may be located in a cloud, even though it is not shown in a cloud in FIG. 6. On the other hand, computer 601 is not required to be in a cloud except to any extent as may be affirmatively indicated.

PROCESSOR SET 610 includes one, or more, computer processors of any type now known or to be developed in the future. Processing circuitry 620 may be distributed over multiple packages, for example, multiple, coordinated integrated circuit chips. Processing circuitry 620 may implement multiple processor threads and/or multiple processor cores. Cache 621 is memory that is located in the processor chip package(s) and is typically used for data or code that should be available for rapid access by the threads or cores running on processor set 610. Cache memories are typically organized into multiple levels depending upon relative proximity to the processing circuitry. Alternatively, some, or all, of the cache for the processor set may be located “off chip.” In some computing environments, processor set 610 may be designed for working with qubits and performing quantum computing.

Computer readable program instructions are typically loaded onto computer 601 to cause a series of operational steps to be performed by processor set 610 of computer 601 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 621 and the other storage media discussed below. The program instructions, and associated data, are accessed by processor set 610 to control and direct performance of the inventive methods. In computing environment 600, at least some of the instructions for performing the inventive methods may be stored in block 200 in persistent storage 613.

COMMUNICATION FABRIC 611 is the signal conduction path that allows the various components of computer 601 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 612 is any type of volatile memory now known or to be developed in the future. Examples include dynamic type random access memory (RAM) or static type RAM. Typically, volatile memory 612 is characterized by random access, but this is not required unless affirmatively indicated. In computer 601, the volatile memory 612 is located in a single package and is internal to computer 601, but, alternatively or additionally, the volatile memory may be distributed over multiple packages and/or located externally with respect to computer 601.

PERSISTENT STORAGE 613 is any form of non-volatile storage for computers that is now known or to be developed in the future. The non-volatility of this storage means that the stored data is maintained regardless of whether power is being supplied to computer 601 and/or directly to persistent storage 613. Persistent storage 613 may be a read only memory (ROM), but typically at least a portion of the persistent storage allows writing of data, deletion of data and re-writing of data. Some familiar forms of persistent storage include magnetic disks and solid state storage devices. Operating system 622 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 614 includes the set of peripheral devices of computer 601.

Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 623 may include components such as a display screen, speaker, microphone, wearable devices (such as goggles and smart watches), keyboard, mouse, printer, touchpad, game controllers, and haptic devices. Storage 624 is external storage, such as an external hard drive, or insertable storage, such as an SD card. Storage 624 may be persistent and/or volatile. In some embodiments, storage 624 may take the form of a quantum computing storage device for storing data in the form of qubits. In embodiments where computer 601 is required to have a large amount of storage (for example, where computer 601 locally stores and manages a large database) then this storage may be provided by peripheral storage devices designed for storing very large amounts of data, such as a storage area network (SAN) that is shared by multiple, geographically distributed computers. IoT sensor set 625 is made up of sensors that can be used in Internet of Things applications. For example, one sensor may be a thermometer and another sensor may be a motion detector.

NETWORK MODULE 615 is the collection of computer software, hardware, and firmware that allows computer 601 to communicate with other computers through WAN 602. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 615 are performed on the same physical hardware device. In other embodiments (for example, embodiments that utilize software-defined networking (SDN)), the control functions and the forwarding functions of network module 615 are performed on physically separate devices, such that the control functions manage several different network hardware devices.

Computer readable program instructions for performing the inventive methods can typically be downloaded to computer 601 from an external computer or external storage device through a network adapter card or network interface included in network module 615. WAN 602 is any wide area network (for example, the internet) capable of communicating computer data over non-local distances by any technology for communicating computer data, now known or to be developed in the future. In some embodiments, the WAN 012 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 603 is any computer system that is used and controlled by an end user (for example, a customer of an enterprise that operates computer 601), and may take any of the forms discussed above in connection with computer 601. EUD 603 typically receives helpful and useful data from the operations of computer 601. For example, in a hypothetical case where computer 601 is designed to provide a recommendation to an end user, this recommendation would typically be communicated from network module 615 of computer 601 through WAN 602 to EUD 603. In this way, EUD 603 can display, or otherwise present, the recommendation to an end user. In some embodiments, EUD 603 may be a client device, such as thin client, heavy client, mainframe computer, desktop computer and so on.

REMOTE SERVER 604 is any computer system that serves at least some data and/or functionality to computer 601. Remote server 604 may be controlled and used by the same entity that operates computer 601. Remote server 604 represents the machine(s) that collect and store helpful and useful data for use by other computers, such as computer 601. For example, in a hypothetical case where computer 601 is designed and programmed to provide a recommendation based on historical data, then this historical data may be provided to computer 601 from remote database 630 of remote server 604.

PUBLIC CLOUD 605 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 605 is performed by the computer hardware and/or software of cloud orchestration module 641. The computing resources provided by public cloud 605 are typically implemented by virtual computing environments that run on various computers making up the computers of host physical machine set 642, which is the universe of physical computers in and/or available to public cloud 605. The virtual computing environments (VCEs) typically take the form of virtual machines from virtual machine set 643 and/or containers from container set 644. It is understood that these VCEs may be stored as images and may be transferred among and between the various physical machine hosts, either as images or after instantiation of the VCE. Cloud orchestration module 641 manages the transfer and storage of images, deploys new instantiations of VCEs and manages active instantiations of VCE deployments. Gateway 640 is the collection of computer software, hardware, and firmware that allows public cloud 605 to communicate through WAN 602.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 606 is similar to public cloud 605, except that the computing resources are only available for use by a single enterprise. While private cloud 606 is depicted as being in communication with WAN 602, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 605 and private cloud 606 are both part of a larger hybrid cloud.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Having described preferred embodiments of adaptive process representation (which are intended to be illustrative and not limiting), it is noted that modifications and variations can be made by persons skilled in the art in light of the above teachings. It is therefore to be understood that changes may be made in the particular embodiments disclosed which are within the scope of the invention as outlined by the appended claims. Having thus described aspects of the invention, with the details and particularity required by the patent laws, what is claimed and desired protected by Letters Patent is set forth in the appended claims.

1. A computer-implemented method of process analysis, comprising:
determining attributes of an event log relating to a process;
determining attributes of an end task of the process based on a comparison of a vector representation of the end task to vector representations to a set of criteria relating to process representations;
tuning hyper-parameters of a plurality of process mining models based on the attributes of the event log and the attributes of the end task;
ranking the plurality of process mining models based on the attributes of the event log and the attributes of the end task;
mining the event log using a top-ranked process mining model of the plurality of process mining models to generate a process representation;
identifying an inefficiency of the process based on the process representation; and
automatically correcting the inefficiency.

2. The method of claim 1, wherein tuning the hyper-parameters includes using reinforcement learning to identify a set of hyper-parameters for a process mining model that maximizes a reward based on a set of criteria.

3. The method of claim 2, wherein the set of criteria includes fitness, precision, generalization, and simplicity.

4. The method of claim 2, wherein the reinforcement learning further uses a user-defined key performance indicator to identify the set of hyper-parameters.

5. The method of claim 1, wherein ranking the plurality of process mining models includes matching text of the attributes of the end task to text of a knowledge base that describes attributes of a plurality of end tasks as they relate to process models.

6. The method of claim 5, wherein the attributes of the end task and the attributes of the plurality of process mining models are represented as vectors and wherein matching includes identifying similarities between the vectors.

7. The method of claim 5, wherein the attributes of the plurality of end tasks include whether activity executions are important to the end task, whether key process indicators or metric overlays are needed for the end task, whether particular organizational information is needed for the end task, and whether process replay and simulations are needed for the end task.

8. The method of claim 1, wherein the plurality of process models include a process discovery method selected from the group consisting heuristic net, heuristic miner, fuzzy miner, alpha miner, and inductive miner.

9. The method of claim 1, wherein the plurality of process models include a representation selected from the group consisting of business process modeling notation, place/transition nets, process trees, and directly follows graphs.

10. The method of claim 1, wherein automatically correcting the inefficiency includes modifying a software program that performs the process to improve an efficiency of the software program.

11. A computer program product for process analysis, the computer program product comprising a computer readable storage medium having program instructions embodied therewith, the program instructions executable by a hardware processor to cause the hardware processor to:
determine attributes of an event log relating to a process;
determine attributes of an end task of the process based on a comparison of a vector representation of the end task to vector representations to a set of criteria relating to process representations;
tune hyper-parameters of a plurality of process mining models based on the attributes of the event log and the attributes of the end task;
rank the plurality of process mining models based on the attributes of the event log and the attributes of the end task;
mine the event log using a top-ranked process mining model of the plurality of process mining models to generate a process representation;
identify an inefficiency of the process based on the process representation; and
automatically correct the inefficiency.

12. A system of process analysis, comprising:
a hardware processor; and
a memory that stores a computer program which, when executed by the hardware processor, causes the hardware processor to:
determine attributes of an event log relating to a process;
determine attributes of an end task of the process based on a comparison of a vector representation of the end task to vector representations to a set of criteria relating to process representations;
tune hyper-parameters of a plurality of process mining models based on the attributes of the event log and the attributes of the end task;
rank the plurality of process mining models based on the attributes of the event log and the attributes of the end task;
mine the event log using a top-ranked process mining model of the plurality of process mining models to generate a process representation;
identify an inefficiency of the process based on the process representation; and
automatically correct the inefficiency.

13. The system of claim 12, wherein the computer program further causes the hardware processor to use reinforcement learning to identify a set of hyper-parameters for a process mining model that maximizes a reward based on a set of criteria.

14. The system of claim 13, wherein the set of criteria includes fitness, precision, generalization, and simplicity.

15. The system of claim 13, wherein the reinforcement learning further uses a user-defined key performance indicator to identify the set of hyper-parameters.

16. The system of claim 12, wherein the computer program further causes the hardware processor to match text of the attributes of the end task to text of a knowledge base that describes attributes of a plurality of end tasks as they relate to process models.

17. The system of claim 16, wherein the attributes of the end task and the attributes of the plurality of process mining models are represented as vectors and wherein matching includes identifying similarities between the vectors.

18. The system of claim 16, wherein the attributes of the plurality of end tasks include whether activity executions are important to the end task, whether key process indicators or metric overlays are needed for the end task, whether particular organizational information is needed for the end task, and whether process replay and simulations are needed for the end task.

19. The system of claim 12, wherein the plurality of process models include a process discovery method selected from the group consisting heuristic net, heuristic miner, fuzzy miner, alpha miner, and inductive miner.

20. The system of claim 12, wherein the computer program further causes the hardware processor to modify a software program that performs the process to improve the efficiency of the software program.
